(19) United States
(12) Patent Application Publication
(10) Pub. No.: US 2018/0349691 A1
(43) Pub. Date: Dec. 6, 2018

(54) SYSTEMS AND METHODS FOR PRESENTATION OF HANDWRITING INPUT

(71) Applicant: Lenovo (Singapore) Pte. Ltd., New Tech Park (SG)

(72) Inventors: Grigori Zaitsev, Durham, NC (US); Axel Ramirez Flores, Cary, NC (US); Thomas Daniel Russell, Durham, NC (US); Charles Ross Eskridge, Cary, NC (US)

(21) Appl. No.: 15/609,248

(22) Filed: May 31, 2017

(51) Int. Cl. G06K 9/00; G06F 3/0488; G06K 9/22

(52) U.S. Cl. CPC G06K 9/00422; G06K 9/222; G06F 3/04883

(57) ABSTRACT

In one aspect, a device includes at least one processor, a touch-enabled pad accessible to the at least one processor, a display accessible to the at least one processor, and storage accessible to the at least one processor. The storage bears instructions executable by the at least one processor to present a representation of first handwriting on the display, receive first user input directed to a location within the representation as presented on the display, and receive second user input via the touch-enabled pad that includes second handwriting, and the instructions are also executable by the at least one processor to present a representation of the second handwriting beginning at the location.

### BACKGROUND

In today's technology marketplace, there are certain applications and devices that allow for note taking and drawing using a stylus. However, as recognized herein, when initial handwriting input is directed to a device and then the user wishes to edit the initial input or provide additional input in between two parts of the initial input, it is often difficult and frustrating for the user to do so effectively and accurately, if it can be done at all. There are currently no adequate solutions to the foregoing computer-related, technological problem.

### SUMMARY

Accordingly, in one aspect a device includes at least one processor, a touch-enabled pad accessible to the at least one processor, a display accessible to the at least one processor, and storage accessible to the at least one processor. The storage bears instructions executable by the at least one processor to present a representation of first handwriting on the display, receive first user input directed to a location within the representation as presented on the display, present an indicator at the location, and receive second user input via the touch-enabled pad. The second user input includes second handwriting, and the instructions are further executable by the at least one processor to present a representation of the second handwriting beginning at the location.

In another aspect, a method includes presenting a document on a display accessible to a device, receiving first user input directed to a particular location within an input area of the document as presented on the display, and receiving second user input via a writing pad. The second user input includes handwriting of one or more alphabetical characters. The method also includes inserting a representation of the second user input into the document as presented on the display with a first portion of the representation being inserted at least adjacent to the particular location to the right of the particular location.

In still another aspect, an apparatus includes a first processor, a network adapter, and storage bearing instructions executable by a second processor of a device. The instructions are executable for presenting a representation of first handwriting on a display accessible to the second processor, receiving first user input directed to a particular location within the representation as presented on the display, and receiving second user input via a touch-enabled pad that includes second handwriting. The instructions are also executable for inserting a representation of the second handwriting beginning at the particular location. The first processor transfers the instructions to the device over a network via the network adapter.

The details of present principles, both as to their structure and operation, can best be understood in reference to the accompanying drawings, in which like reference numerals refer to like parts, and in which:

### BRIEF DESCRIPTION OF THE DRAWINGS

FIGS. 1 and 3 are block diagrams of example systems in accordance with present principles;

FIG. 2 is a block diagram of an example network of devices in accordance with present principles;

FIGS. 4-7 and 9 are example user interfaces (UIs) in accordance with present principles; and

FIG. 8 is a flow chart of an example algorithm in accordance with present principles.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

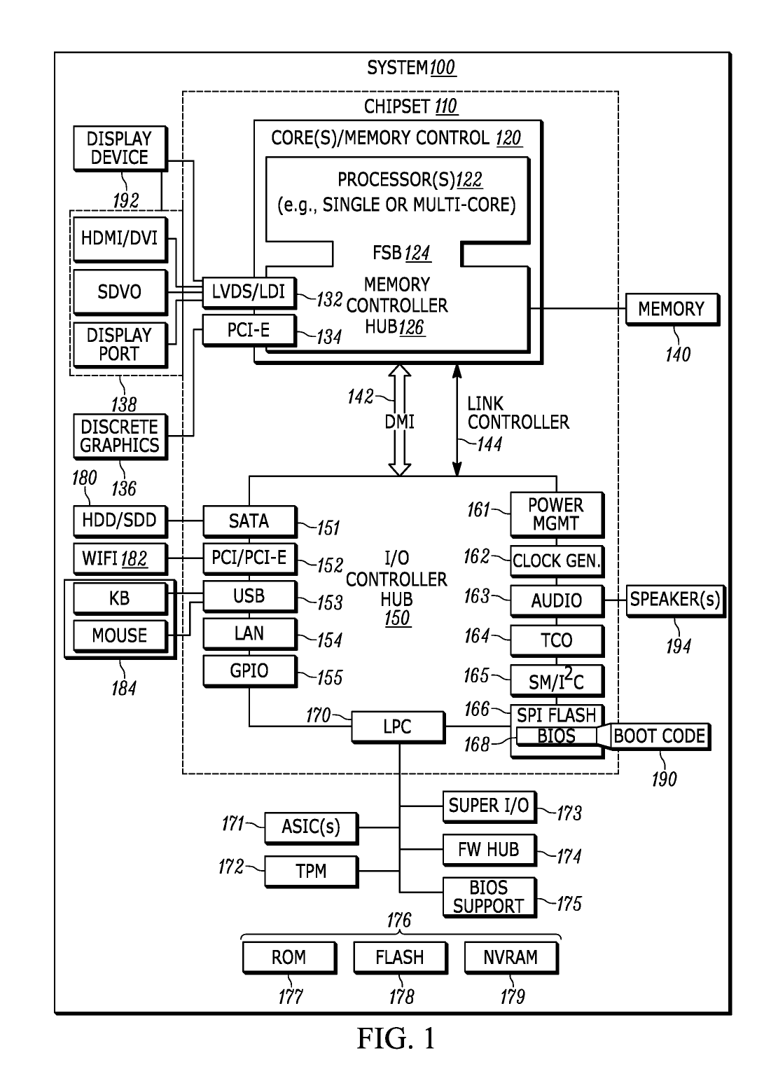

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for clarity, in some embodiments the system 100 may include a gyroscope that senses and/or measures the orientation of the system 100 and provides input related thereto to the processor 122, as well as an accelerometer that senses acceleration and/or movement of the system 100 and provides input related thereto to the processor 122. Still further, the system 100 may include an audio receiver/microphone that provides input from the microphone to the processor 122 based on audio that is detected, such as via a user providing audible input to the microphone, and a camera that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Also, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

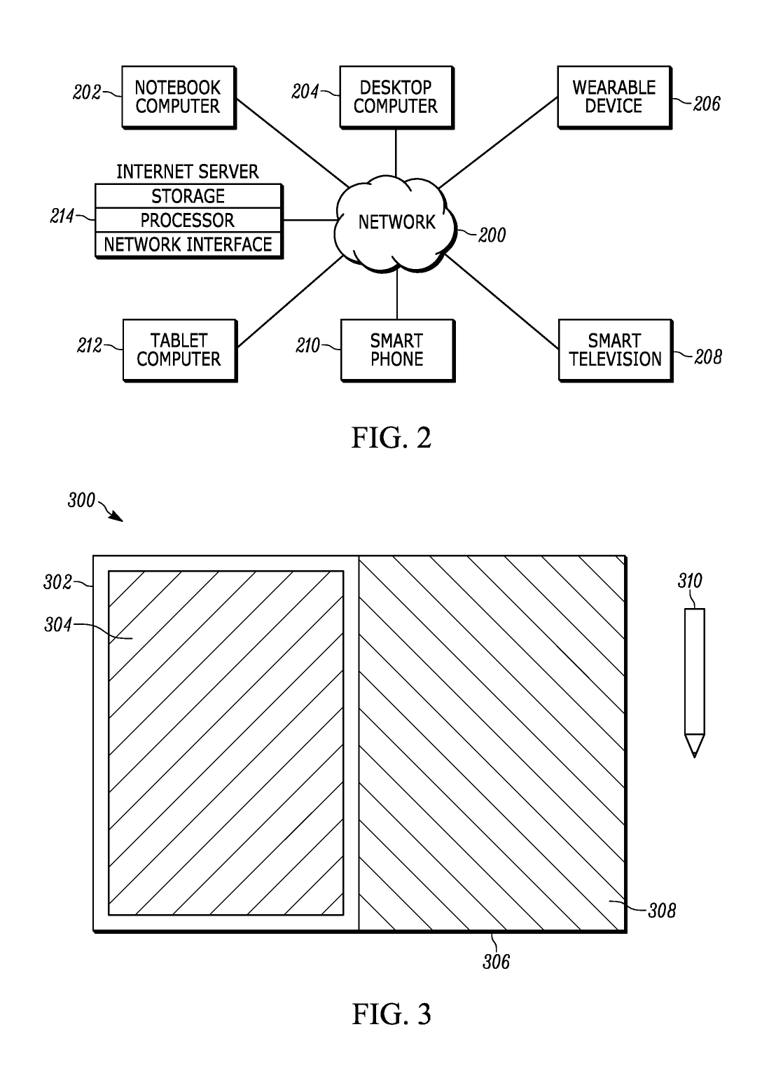

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

Continuing now in reference to FIG. 3, it shows an example of one type of device 300 that may be used in accordance with present principles. The device may be a laptop/tablet hybrid, such as a device from the Lenovo Yoga Book series of devices. The device 300 may include a display assembly 302 that includes a touch-enabled display 304 on which images, video, documents, and other visual content may be presented. The device 300 may also include a touch-enabled writing/drawing pad assembly 306 that includes a touch-enabled pad/sensor 308 to which input from a stylus 310 may be directed and sensed, and also to which touch-based input from the body part of a person may be directed and sensed. The stylus 310 may be an electromagnetic resonance (EMR) stylus or an active electrostatic (AES) stylus in some examples, and may even have pressure sensitivity if desired.

As may be appreciated from FIG. 3, the assembly 306 is distinct from the assembly 302, though coupled together. Notwithstanding, it is to be understood that in other embodiments the touch-enabled display 304 may itself be a writing/drawing pad to which input from the stylus 310 and from a person may be directed in accordance with present principles.

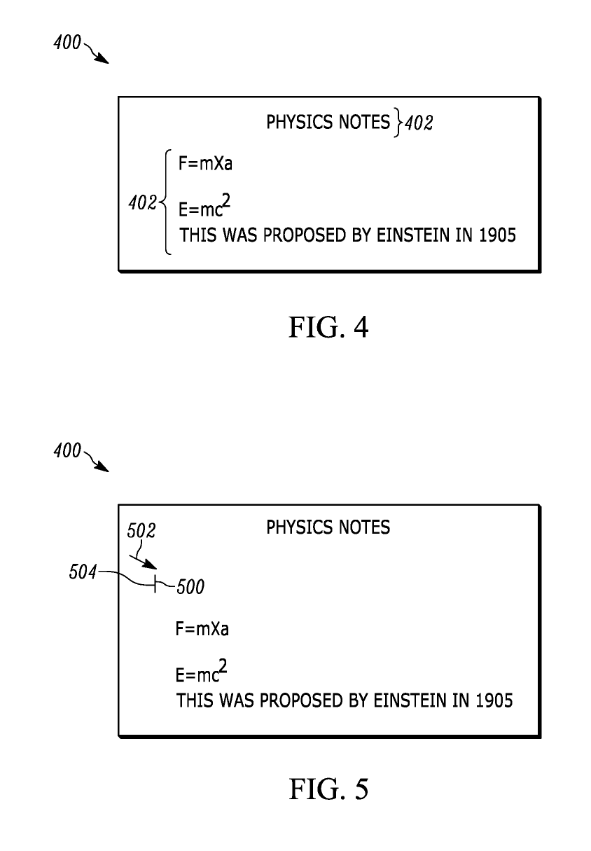

FIG. 4 shows an example document 400 presented on a display of a device undertaking present principles, such as the display 304 of the device 300 described above. The document 400 may be a note taking document showing representations of handwriting input in typographic text characters 402 as shown in FIG. 4. It is to be understood that handwriting input may be entered to a touch-enabled pad such as the pad 308, and then handwriting recognition software may be executed to identify characters from the handwriting input that are then converted to typographic text characters and presented on the display in an order and position in which they were written as received at the pad.

As may be appreciated from FIG. 4, the example document 400 includes and/or establishes a unitary input area/input field, rather than having separate input fields separated by another area to which input may not be directed. Accordingly, input to the unitary area/field may be directed to and presentable at any given location within the input area/field based on writing provided to the writing pad of the device, rather than, for example, any input that might be received being presented either at the beginning or end of the input area/field or document 400 itself.

Accordingly, when input such as touch-based input is directed to a location 500 within the input area/field of the document 400 as shown in FIG. 5, such as touch-based input received at the location 500 as presented on the touch-enabled display of the device, the device may identify the location 500 as a location at which to begin inserting one or more additional representations of handwriting input responsive to the additional handwriting input being received at the device's writing pad. In addition to or in lieu of touch input by the user to select the location 500, the user may also move a text or mouse cursor to the location 500, such that based on the cursor being moved to the location 500 the additional representations may be presented at the location 500 responsive to the additional handwriting input being received at the device's writing pad.

As also shown in FIG. 5, one or more graphical indicators such as an arrow 502 and cursor 504 may be presented to visually indicate to the user the location 500 at which the additional handwriting input will be inserted between previous portions of handwriting input as already represented in the document 400. The indicators 502, 504 may be presented, for example, responsive to touch input to the location 500 without the indicators 502, 504 having been presented in the input area/field prior to receipt of the touch input.

After selecting the location 500, the user may then enter additional handwriting input to the separate writing pad (such as the pad 308) or to the display itself on which the document 400 is presented. If the additional handwriting is directed to the display itself, note that owing to the user having already selected the location 500, the user need not necessarily begin to write at or over top of the location 500 in order for the representation to then be mapped to and presented beginning at the location 500, but may instead begin to write elsewhere on the display. In embodiments where the separate writing pad is used for handwriting input instead of the display, owing to the user having already selected the location 500, the user need not necessarily begin to write at or over top of a same area of the writing pad otherwise mapped to the location 500 and/or mapped to where the initial handwriting input defining the location 500 was received in order for the representation of the additional handwriting input to then be presented beginning at the location 500.

Thus, the user may direct the additional handwriting input to any touch-enabled location of the display or writing pad while the document 400 is presented, and the device may still insert the representation of the additional input beginning at the location 500. This may be done even if respective locations of the writing pad or display would be otherwise mapped/linked to corresponding locations within the document 400 as presented on the display so that input otherwise directed to a given location on the writing pad or display would be presented at its correspondingly mapped location within the document.

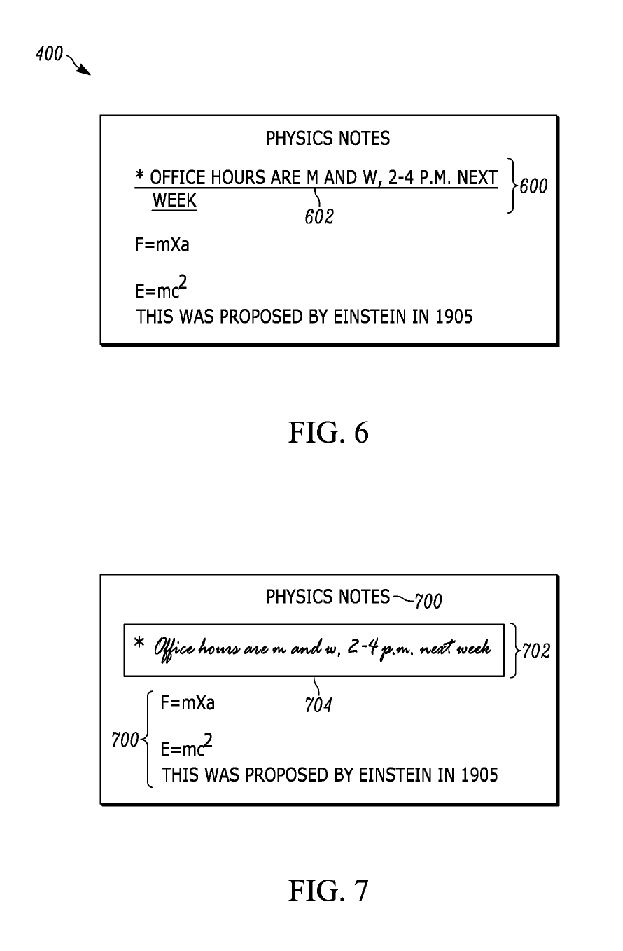

Now in reference to FIG. 6, it shows a representation 600 of the additional handwriting input, again as typographic text characters. It is to be understood that the additional handwritten input has been recognized using handwriting recognition software so that the typographic text characters 600 may be presented as part of the document 400. The representation 600 may also be indicated as being an edit or addition to the document 400 relative to its previous form based on the underlining 602 that is shown. Furthermore, even if the user had handwritten all of the additional input in a single line, left to right, across the display or writing pad, the device may reformat the additional input such that it may be presented over multiple lines within the document 400 once converted and scaled to be the same size or substantially the same size as surrounding text portions.

Another example of present principles is shown in FIG. 7. Again representations 700 of the initial input and representations 702 of the additional input are shown, but in this example the representations 700 and 702 are presented as respective tracings of the respective handwriting itself as received at the display or writing pad. Note that as shown in FIG. 7, the representation 702 may be indicated as being an edit or addition based on the outlining 704 that is shown around the additional representations 702.

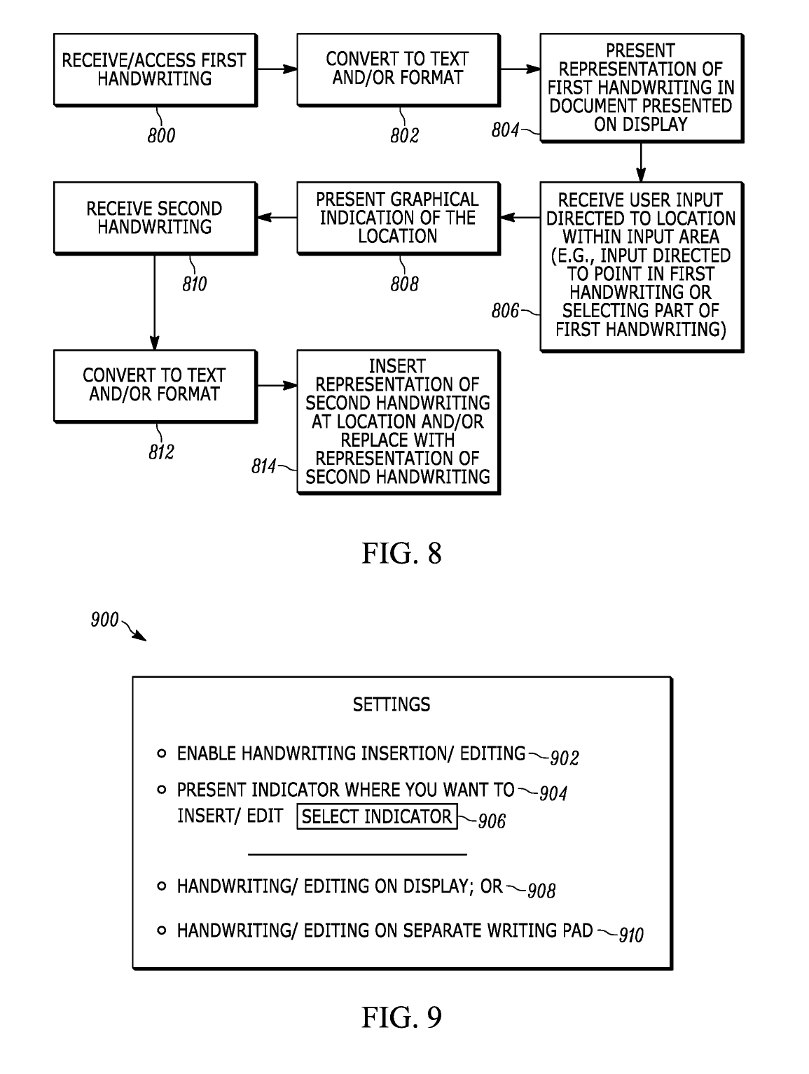

Referring now to FIG. 8, it shows example logic that may be executed by a device such as the system 100 in accordance with present principles. Beginning at block 800, the logic may receive first handwriting (and/or otherwise accesses data related to it if the first handwriting were previously received and stored). The logic may then move to block 802 where the first handwriting may be converted to text and/or formatted. Formatting may be done, for example, to fit the converted typographic text characters within the confines of a document at a particular scale, font, and/or font size. This formatting and the other formatting described herein may be performed, for example, using word processing software, text formatting software, and/or the handwriting recognition software itself.

From block 802 the logic may move to block 804 where the logic may present on a display the representation of the first handwriting input as converted to typographical text characters and/or as formatted. The logic may then proceed to block 806 where the logic may receive user input directed to a (e.g., arbitrary) location within a unitary input area of the document, and may identify the location's coordinates (e.g., X-Y coordinates) within the document for mapping of ensuing second handwriting input to the location. The user input to the location received at block 806 may be a predefined gesture such as a double tap of a stylus tip or finger against the writing surface (e.g., pad or display), triple tap of a stylus tip or finger against the writing surface, twist of a stylus tip or finger against the writing surface, etc., to distinguish from input that when provided to the writing surface would otherwise have its representation be presented at a location within the document that is mapped to the location on the writing surface to which the input was directed. For instance, the user input received at block 806 may be a triple tap stylus gesture that is directed to a particular point within the document as presented on the display, with all three taps being received within a threshold time.

Additionally, should a user wish to edit or replace a certain part of the representation of the first handwriting rather than to insert additional text, the input received at block 806 may select the part to be edited or replaced, rather than the input at block 806 being directed to a single point of the document as presented on the display. In this example, the gesture selecting part of the representation of the first handwriting (e.g., a given character, word or phrase) may be a gesture circling or outlining the portion to be edited or replaced. Notwithstanding, in some embodiments selection of a single point may be interpreted by the device as selection of a particular word for editing that is at least in part presented at that point.

From block 806 the logic of FIG. 8 may then move to block 808. At block 808 the logic may present a graphical indication of the location, such as the arrow 502 and cursor 504 described above. Additionally, should a word or phrase in the representation be selected rather than a single point, the graphical indication may be presented as an oval surrounding or line underlining the selected character, word, or phrase to indicate the location.

After block 808 the logic may move to block 810 where the logic may receive second handwriting, a representation of which is to be presented beginning at the location. However, before being presented, at block 812 the logic may first convert the second handwriting to typographical text characters and/or format the second handwriting. The second handwriting may be formatted to appear the same as the representations of the first handwriting, such as formatting the second handwriting in the same font and font size as the representations of the first handwriting. Formatting may also include wrapping a single line of handwriting around into multiple lines (e.g., in paragraph form) if all of the representation of the second handwriting cannot be fit in a single line beginning at the location selected at block 806 (once in the converted font and font size), even if the second handwriting itself was all written in a single line.

Furthermore, if the user provided the second handwriting with an inconsistent or non-straight baseline (e.g., words were handwritten diagonally or at a non-horizontal angle relative to an upright perspective of the writing pad), formatting may include adjusting the baseline so that the representation of the second input as presented on the display may be oriented with a horizontal, normalized baseline.

Formatting may also include normalizing or otherwise scaling the representation of the handwriting to all be the same font size, even if the second handwriting itself as received at the writing pad had characters or words of varying sizes. The same font size may be for a particular line of text within the document in which the representation of the second input is to be presented (e.g., with the first or last word of the line being the reference word for which other words are scaled to match), may be the average font size of all representations within a line, paragraph, or the whole document, or may otherwise be the same font size as other portions of the representation of the second handwriting and even the representation of the first handwriting itself. Sizing may also be scaled based on user preferences, as may be received at a text editor or font size field presented with the document.

Even further, it is to be understood that when normalizing or otherwise scaling the representation of the handwriting to all be the same font size, ascenders and descenders may be ignored for characters such as p, d, q, h, etc. Moreover, if words as handwritten have been separated by disproportional or varying distances from each other, the distances between the words may also be normalized so that the space in between words is equal or at least substantially equal.

The foregoing formatting techniques may also be used at block 802 for the first handwriting as well.

Still in reference to FIG. 8, the logic may move from block 812 to block 814. At block 814 the logic may present on the display the representation of the second handwriting beginning at the location selected at block 806, should a particular point within the document have been identified as selected at block 806 (rather than a particular portion of the representation of the first handwriting input being selected for editing). When inserting the representation of the second handwriting at block 814, if part of the representation of the first handwriting appears next to or below the insertion point, that part of the representation of the first handwriting may be moved further right and/or down in the document to make space for the representation of the second handwriting.

Also at block 814, if a particular character, word, or series of words from the representation of the first handwriting have instead been selected at block 806 for editing, at block 814 the logic may replace the selected portion of the representation of the first handwriting with the representation of the second handwriting. Other portions of the representation of the first handwriting that are next to or below the replacement point may also be moved further right and/or down as needed to make space.

Continuing the detailed description in reference to FIG. 9, a user interface (UI) 900 is shown that may be presented on a display of a device for configuring settings in accordance with present principles. Each of the options to be discussed below may be selectable using the respective radio button shown adjacent to the respective option.

The UI 900 may include a first option 902 that is selectable to enable insertion of representations of additional handwriting and/or editing of previously-input handwriting as described herein. For example, selection of the option 902 may configure the device to undertake the logic set forth above in reference to FIG. 8.

The UI 900 may also include a second option 904 to enable presentation of a graphical indicator at a location responsive to selection of the location, as described herein. In some examples, the option 904 may even be accompanied by a selector 906 that is selectable to provide a command to present another UI from which a particular graphical indicator may be selected by the user for use to indicate a location that has been selected.

The UI 900 of FIG. 9 may also include options 908, 910 that are respectively selectable to enable detection on a touch-enabled display of handwriting for insertion and editing, and to enable detection of such on a separate writing pad such as the pad 308 described above.

Though not shown for simplicity, still other options may be presented on the UI 900. For example, one or more options may be provided to enable formatting, scaling, and/or normalization as described herein. Options may also be presented to either present representations of handwriting as text or tracings of the handwriting itself. Options may also be presented for a user to define a desired font type, font size, etc. should typographical text representations be enabled. Still further, options may be presented for how to select a portion of a representation to be edited, such as an option to select by circling the portion to be edited, an option to underline the portion to be edited, and an option to highlight the portion to be edited using a particular color different from other parts of the document.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory, propagating signal and/or a signal per se.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
at least one processor;
a touch-enabled pad accessible to the at least one processor;
a display accessible to the at least one processor; and
storage accessible to the at least one processor and bearing instructions executable by the at least one processor to:
present a representation of first handwriting on the display;
receive first user input directed to a location within the representation as presented on the display;
receive second user input via the touch-enabled pad, the second user input comprising second handwriting; and
present a representation of the second handwriting beginning at the location.

2. The device of claim 1, wherein the respective representations of the first and second handwriting are respective representations in typographic text, the respective representations in typographic text being respectively identified from the first and second handwriting based at least in part on execution by the at least one processor of handwriting recognition software.

3. The device of claim 1, wherein the respective representations of the first and second handwriting are respective tracings of the first and second handwriting.

4. The device of claim 1, wherein the touch-enabled pad is separate from a display assembly comprising the display.

5. The device of claim 1, wherein the instructions are executable by the at least one processor to:
present an indicator at the location, wherein the indicator comprises a cursor.

6. The device of claim 1, wherein the representation of the first handwriting as presented on the display comprises at least first and second portions, and wherein the representation of the second handwriting is presented beginning at the location by inserting the representation of the second handwriting between the first and second portions.

7. The device of claim 1, wherein the display is a touch-enabled display, and wherein the first user input comprises touch-based input to the touch-enabled display that is directed to the location.

8. The device of claim 1, wherein the first user input is identified as selecting a first portion of the representation of the first handwriting as presented on the display, wherein the first portion does not comprise an entirety of the representation of the first handwriting as presented on the display, wherein at least part of the first portion is presented at least adjacent to the location, and wherein the instructions are executable by the at least one processor to:
present the representation of the second handwriting beginning at the location by replacing the first portion with the representation of the second handwriting.

9. The device of claim 1, wherein the first handwriting is received via third user input received via the touch-enabled pad, and wherein the second user input is not received at a same area of the touch-enabled pad at which the third user input is received.

10. A method, comprising:
presenting a document on a display accessible to a device;
receiving first user input directed to a particular location within an input area of the document as presented on the display;
receiving second user input via a writing pad, the second user input comprising handwriting of one or more alphabetical characters; and
inserting a representation of the second user input into the document as presented on the display with a first portion of the representation being inserted at least adjacent to the particular location to the right of the particular location.

11. The method of claim 10, wherein the document comprises a unitary input area comprising the particular location and at least one additional location to which input may also be directed, and wherein the particular location and the at least one additional location are not separated by another area to which input may not be directed.

12. The method of claim 10, comprising:
presenting, responsive to receipt of the first user input, a graphical element on the display that visually indicates the particular location to which the first user input is directed.

13. The method of claim 10, wherein the writing pad comprises a touch-enabled sensor that is included as part of a display assembly that comprises the display.

14. The method of claim 13, wherein the second user input is received at a location of the writing pad that is not overlaid on the portion of the display presenting the particular location within the input area of the document, wherein the second user input is received at a location of the writing pad that is not underlaid on the portion of the display presenting the particular location within the input area of the document, the second user input still being received while the display presents the particular location within the input area of the document.

15. The method of claim 10, wherein the writing pad does not form part of a display assembly that comprises the display but forms part of a separate touch-enabled assembly coupled to the device.

16. An apparatus, comprising:
a first processor;
a network adapter; and
storage bearing instructions executable by a second processor of a device for:
presenting a representation of first handwriting on a display accessible to the second processor;
receiving first user input directed to a particular location within the representation as presented on the display;
receiving second user input via a touch-enabled pad, the second user input comprising second handwriting; and
inserting a representation of the second handwriting beginning at the particular location;
wherein the first processor transfers the instructions to the device over a network via the network adapter.

17. The apparatus of claim 16, wherein the instructions are executable by the processor for:
receiving the second user input as a single line of input directed to the touch-enabled pad; and
inserting the representation of the second handwriting beginning at the particular location by presenting the representation of the second handwriting in multiple lines on the display.

18. The apparatus of claim 16, wherein the representations of the first handwriting and the second handwriting are presented on the display as part of a document, wherein the document comprises a unitary input area comprising the particular location and additional locations before and after the particular location to which input may also be directed, and wherein the particular location and the additional locations are not separated by another area to which input may not be directed.

19. The apparatus of claim 16, wherein the representations of the first handwriting and the second handwriting are presented as typographic characters.

20. The apparatus of claim 16, wherein the instructions are executable by the processor for:
presenting, responsive to receipt of the first user input, a graphical indicator at the particular location.
